(19) United States
(12) Patent Application Publication
(10) Pub. No.: US 2012/0107103 A1
(43) Pub. Date: May 3, 2012

(54) GAS TURBINE SHROUD WITH CERAMIC ABRADABLE LAYER

(76) Inventors: Yoshitaka Kojima, Hitachi (JP); Hideyuki Arikawa, Mito (JP); Akira Mebata, Kitaibaraki (JP); Tadashi Kasuya, Hitachi (JP); Hiroyuki Doi, Tokai (JP); Kunihiro Ichikawa, Hitachinaka (JP); Takao Endo, Hitachi (JP); Kazuto Mikazuki, Hitachi (JP); Hidetoshi Kuroki, Hitachi (JP)

(21) Appl. No.: 13/242,951

(22) Filed: Sep. 23, 2011

(30) Foreign Application Priority Data
Sep. 28, 2010 (JP) 2010-216332

(51) Int. Cl. F01D 11/12; B23P 15/00

(52) U.S. Cl. 415/173.4; 29/889.22

(57) ABSTRACT

A gas turbine shroud includes a ceramic abradable coating superior in abradable property and durability. The gas turbine ceramic abradable coating of the present invention is configured by an abradable metal layer and a porous ceramic abradable layer (hardness RC15Y: 80±3), the porous ceramic abradable layer is provided with slit grooves by machining work, and a slit groove width is 0.5 to 5 mm. Thereby, the abradable property, and durability against a thermal cycle and high-temperature oxidation are improved.

### BACKGROUND OF THE INVENTION

The present invention relates to a gas turbine shroud for use in thermal power generation and compound power generation plants and the like, and particularly relates to a gas turbine shroud having a ceramic abradable coating which is used for regulation of a gap between a rotor blade and a stator of a gas turbine, and reduces fluid leakage out of the gap.

The work efficiency of the gas turbine used in a power generation plant affects the amount of a fluid which rotates a turbine blade to generate power (rotational torque). The gap regulation technique of how to reduce the fluid which leaks out of the gap between the stator portion and a rotary portion (rotor blade) of a turbine determines the turbine performance. The gap regulation technique is required to have the function of abrading only a seal member and reducing the thickness of the seal member (abradability) without causing a damage to both the stator portion and the rotary portion even if the stator portion and the rotary portion are in contact with each other at the worst. As a result, by providing a seal member in the gap between the stator portion and the rotary portion, the gap can be made closer and closer to zero, and the fluid which leaks out of the gap can be made close to zero, which can greatly contribute to enhancement of efficiency. In the case of the shroud for a gas turbine, especially with respect to the gap regulation between an initial stage rotor blade and a stator (initial stage shroud), ceramics with less oxidative damage is required, since the operation temperature reaches 800° C. or higher.

With regard to a ceramic abradable coating, for example, JP-A-2006-36632 proposes a method for applying an abradable coating consisting of ceramics. As the method for applying an abradable ceramic coating having a fixed grid pattern to a base member, description is made to the step of plasma-spraying an initial bond coat onto the base member in the atmosphere, the step of applying a dense vertically cracked thermal barrier coating, the step of thermally treating the aforesaid initial bond coat and the aforesaid thermal barrier coating, the step of applying an abradable ceramic coating having a fixed grid pattern onto the aforesaid thermal barrier coating, and the step of subjecting the aforesaid abradable ceramic coating to heat treatment.

In this method, the bond layer on the base member and the dense vertically cracked thermal barrier coating are thermal barrier coatings (TBC), and have the configuration in which a porous ceramic abradable coating is formed in a grid pattern state on its surface. The ceramic abradable coating is provided on a hot gas pass surface of a shroud, and is opposed to a rotor blade tip end portion of an Ni group heat resistant alloy. As the method for applying an abradable ceramics coating having a grid pattern onto the base member, description is made to a method for thermally spraying by using a masking material, and a method for thermally spraying while drawing a grid pattern by using a compact gun with low output. It is found that in the method using a masking material, a uniform porous film cannot be obtained due to the influence of the masking material in porous ceramics thermal spraying, and adhesiveness of the end portion of a thermally sprayed coating film especially with a conical sectional shape cannot be sufficiently ensured, as a result of the examination of the present inventor, et al.

As a result of the examination of the abrasion element test with an Ni group heat resistant alloy, about an abradable ceramic coating, it is clear that in the case of a thermally sprayed coating film with a conical sectional shape, part of the thermally sprayed coating film is damaged and falls off. Meanwhile, it is found that in an abradable ceramic coating with a smooth plane which is not in the shape as above, frictional heat at the time of abrasion is not effused, abrasion debris which occurs due to abrasion cannot be discharged, seizure of the Ni group heat resistant alloy occurs, and the abradable property cannot be exhibited.

Accordingly, for a ceramic abradable coating, both an abradable property and long-term durability need to be ensured, and the present known example has the problem in ensuring long-term durability.

For example, JP-A-2006-104577 provides an abradable coating which has microcracks of a coating film perpendicular method (4 to 50 per inch, with intervals of 6.4 to 0.5 mm) by plasma thermal spraying of a gadolinia zirconia coating film. In this case, the feature is such that under specific thermal spraying conditions, microcracks are formed, an abradable coating film is obtained, and machining work, heat treatment and the like are not needed. Due to microcracks, no specific description is available about the width of the crack grooves, but it is difficult to consider that the width reaches the order of millimeter. As a result of the examination of the abrasion element test with the Ni group heat-resistant alloy of the present inventor et al., the effect of the cracked thermal barrier coating of the dense vertically cracked thermal barrier coating of JP-A-2006-36632 is sufficiently recognized, but it is also found that the frictional heat at the time of abrasion is not diverged, abrasion debris which occurs in abrasion cannot be discharged, seizure of the Ni group heat-resistant alloy occurs, and abradable property cannot be exhibited.

For example, JP-A-06-57396 provides, as a forming method of a heat barrier thermally sprayed layer, a method for forming a heat barrier thermally sprayed layer, which forms a dense thermally sprayed layer of ceramic powders excellent in the thermal barrier property on a base member, mixed powders of ceramic powders excellent in the thermal barrier property and a predetermined amount of Si₃N₄ powders are thermally sprayed thereon to form a thermally sprayed layer with a high porosity. In this case, although the document describes the formation method of a porous ceramic layer in detail, no description is made to formation of a ceramic thermal barrier thermally sprayed layer is aimed at, and the abradable property required for ceramic abradable coating and the means for ensuring long-term durability.

### BRIEF SUMMARY OF THE INVENTION

An object of the present invention is to provide a gas turbine shroud with a ceramic abradable coating superior in abradable property and durability.

According to the invention, a hot gas passing surface of a shroud facing to a rotor blade of a gas turbine has slits formed by machining on a ceramic abradable layer which is formed by thermal spraying on a metal abradable layer formed by the thermal spraying on a base member.

The shroud for the gas turbine with the ceramic abradable layer of the invention facing to the rotor blade of the gas turbine keeps the abradable property and the durability for long term, whereby a clearance between the shroud and the rotor blade is kept at substantially zero during the long term so that a fluidal leakage through the clearance is kept at substantially zero to keep an operation efficiency high for the long term.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWINGS

FIGS. 1A to 1I show respectively modifications in shape of ceramic abradable coating of the present invention;

FIGS. 2A and 2B show examples of abradable coating of the prior art;

FIG. 3 shows a relationship between a porosity and hardness (HR15Y) of porous ceramic of the present invention;

FIGS. 4A and 4B show schematic views of a high-temperature abrasion test which is used for evaluation of an abradable property;

FIG. 5 is a sketch drawing of a gas turbine shroud;

FIGS. 6A and 6B show respectively modifications of ceramic abradable coating on shroud of the present invention;

FIG. 7 is a block diagram of an abradable property testing apparatus by high-speed rotation;

FIG. 8 shows one example of a sketch drawing of a shroud having an abradable coating of the present invention;

FIG. 9 shows one example of a sectional sketch drawing of a shroud having the abradable coating of the present invention; and

FIG. 10 is a schematic sectional view of a gas turbine using the shroud having the abradable coating of the present invention.

Each of FIGS. 11A-11C is a partially cross sectional view showing a surface treatment of the invention to be applicable to the gas turbine shroud.

### DETAILED DESCRIPTION OF THE INVENTION

A gas turbine ceramic abradable coating according to an embodiment of the present invention provides a gas turbine shroud having a ceramic abradable coating according to a method including a step of thermally spraying an abradable metal layer onto a base member, a step of thermally spraying an abradable ceramic layer thereon, and a step of forming slit grooves on the abradable ceramic layer by machining work.

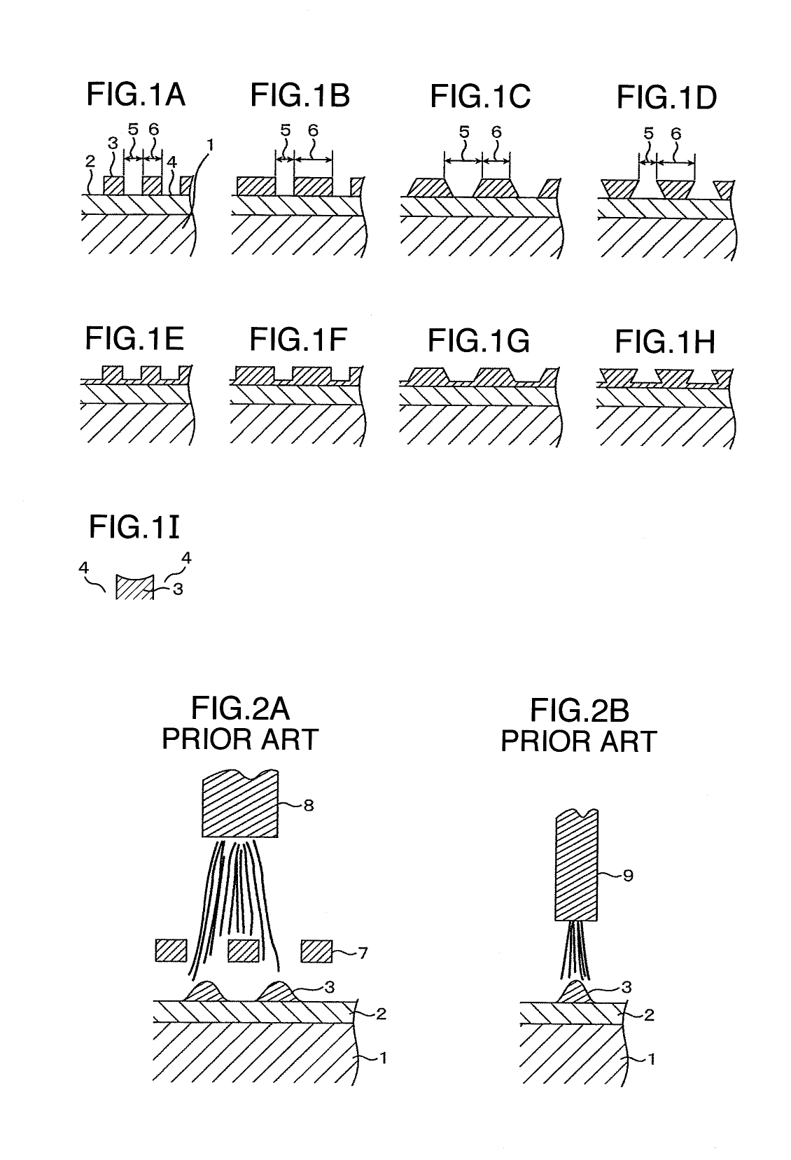

FIGS. 1A to 1I show respective example of a sectional form of a ceramic abradable coating which is obtained according to a method for forming a gas turbine ceramic abradable coating in the present invention.

At a step of forming a slit groove on an abradable ceramic layer by machining work, a sectional shape of the abradable ceramic layer which is divided by the slit groove is rectangular as shown in FIGS. 1A to 1H. An especially desirable sectional shape in the present invention is a square shown in FIG. 1A, a rectangle such as an oblong shown in FIG. 1B, or a trapezoid shown in FIG. 1C or 1D, and the shapes in FIGS. 1E to 1I. In FIG. 1A, reference numeral 1 designates a base member, reference numeral 2 designates an abradable metal layer of a base, reference numeral 3 designates a rectangular ceramic abradable layer, and reference numeral 4 designates a slit groove. A width (rectangular width) of the ceramic abradable layer has a dimension shown by 6 in FIG. 1A, and a slit groove width has a dimension shown by 5 in FIGS. 1A to 1D. The dimensions of 5 and 6 are determined by measurement of the dimensions of the surface portion of the ceramic abradable layer. A gas turbine shroud is provided, which has a ceramic abradable coating in which a width (5 in FIG. 1A) of a rectangle designated by 3 in FIG. 1A divided by the slit groove is 2 to 7 mm, and a ceramic abradable coating in which the hardness of an abradable ceramic layer is a Rockwell superficial hardness (HR15Y) of 80±5, at a step of thermally spraying the abradable ceramic layer. When a surface of the base member has a concave shape and the ceramic abradable layer and the slits are formed by a process shown on FIGS. 1A-1H, a surface of the ceramic abradable layer has a concave shape as shown on FIG. 1I.

FIGS. 2A and 2B show the method for forming the abradable coating of JP-A-2006-36632. FIG. 2A shows a method for rendering and forming the ceramic abradable layer of a grid pattern by thermal spraying with use of masking. FIG. 2B shows a method for rendering and forming a grid pattern by thermal spraying with a compact gun. In these known methods, the sectional shapes of the ceramic abradable layers of the rendered gird patterns are both convex while that of the present invention is rectangular, that is, the surface of the ceramic abradable layer of the present invention is flat or concave.

A method for forming the ceramic abradalbe layer with a rectangular section shown in FIGS. 1A to 1H of the present invention is machining work, and includes, for example, a water jet method (WJ method) and a cutting grindstone work method. The above machining works are performed after ceramic abradable layers are thermally sprayed onto the entire surfaces of the portions requiring the ceramic abradable layers. Accordingly, the thermally spraying mask shown in FIG. 2A is not needed. In the examination of the present inventor, the gap of the thermally spraying mask becomes small, when thermally spraying of a thick layer is performed about 1 mm, and the adherent needs to be removed at each operation, and the working efficiency is reduced.

In the machining work method of the present invention, thermally spraying onto the entire surface is performed, the mask is not required, and the working efficiency is enhanced. In particular, in the WJ method, by interlocking operation of the WJ nozzle and the object to be worked, work of the complicated shapes is enabled. In WJ work, the WJ work conditions can be set to the WJ conditions capable of grinding only the porous ceramic abradable layer by adjusting the WJ work conditions (for example, water spray pressure, nozzle moving speed and the like), grinding of the metal of the underlayer or the base member is hardly performed, and work without a mask can be performed. Further, by adjusting the WJ work conditions, the rectangles in all the shapes of FIGS. 1A to 1D, and the shapes with the ceramic abradable layers partially left as in FIGS. 1E to 1H can be worked. In the shape with the trapezoids and the ceramic abradable layer partially left, the area in close contact with the thermally sprayed layer of the base can be increased, and the effect of preventing peeling and falling off of the rectangular ceramic abradable layer becomes large. When a surface of the base member has a concave shape to face to or surround a turbine rotor and the ceramic abradable coating is formed by thermal spraying without using a mask pattern corresponding to an arrangement of the slits, a slide surface of the ceramic abradable coating arranged between the slits so that the turbine rotor is slidable on the slide surface has a concave shape as shown on FIG. 1I, that is, is prevented from having a convex shape as shown FIGS. 2A and 2B, formed by the thermal spraying with using the mask pattern corresponding to the arrangement of the slits.

The conditions which the present invention should include, that are, (1) abradable property at the temperature of the shroud exposed to the combustion gas of a gas turbine, (2) thermal stress at actuation and stoppage (repetition of heating and cooling), and (3) durability to exposure for a long time at a high temperature, are studied, and the ceramic abradable coating which satisfies all the requirements is found.

As for the abradable property at the temperature of the shroud exposed to the combustion gas of the gas turbine, a sufficient heat resistance is ensured with ZrO₂ ceramics at the temperature of the shroud exposed to the combustion gas of about 800 to 1000° C. However, in the combination of ceramics and a rotor blade material (Ni group heat-resistant alloy), the rotor blade material is abraded, damaged and reduced in thickness unless the ceramic is made porous and the hardness thereof is sufficiently lowered. A ceramic layer is hardly reduced in hardness even at a high temperature, while an Ni group heat resistant alloy is significantly reduced in hardness at 500° C. or higher, and the hardness becomes about 1/10 of that at a room temperature. Accordingly, the hardness of the ceramic abradable layer is a very important parameter, and in order to reduce the hardness, a porous ceramic is required. As the method for forming a porous ceramic, thermally spraying of the mixed powders of ZrO₂ powders and polyester powders is adopted. By changing the ratio of the mixed powders, the porosity of a ZrO₂ ceramic (calculated from the area rate of the ceramic portion of the sectional tissue observation result) can be regulated.

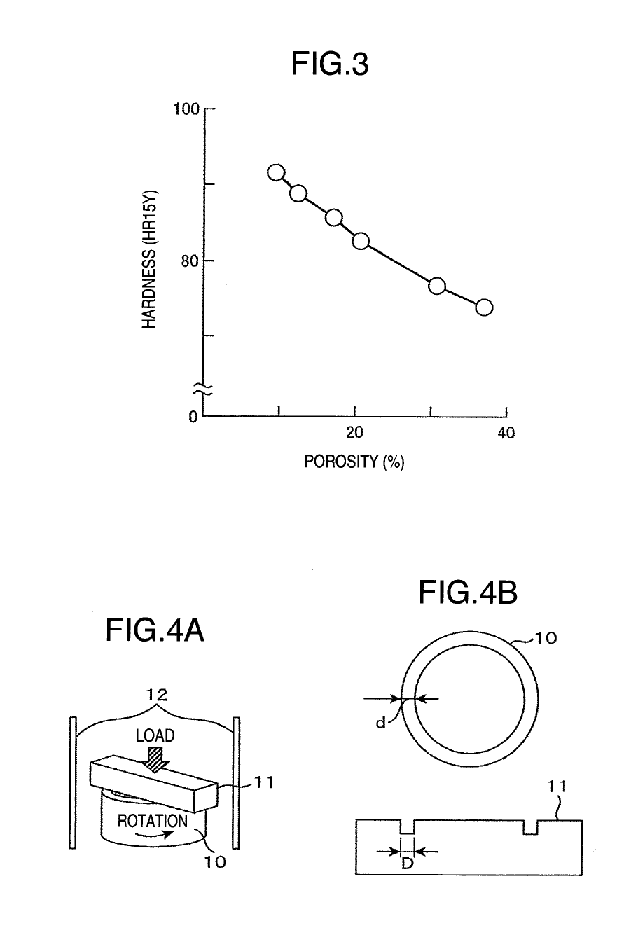

FIG. 3 shows a relationship between the porosity and the hardness (Rockwell superficial hardness, load 15 kg: HR15Y) of the porous ceramic of the present invention. It is found that when the porosities are 9% and 11%, the HR15Ys are 91 and 89, which are relatively hard, whereas when the porosities are 20% and 30%, HR15Ys are 83 and 77, which are very small. When the porosities are 17% and 35%, HR15Ys are 85 and 75.

In the gas turbine shroud provided with the ceramic abradable layer of the present invention, the abradable metal layers are provided as the base layers in all of them shown in FIGS. 1A to 1H. The abradable metal layer is composed of an MCrAlY alloy (M is at least any one of Co and Ni) excellent in high temperature corrosion resistance/oxidation resistance, and is formed to be a coating of a microcrystal structure by reduced pressure atmosphere plasma thermal spraying (LPPS), high speed gas thermal spraying (HVOF) and the like for ensuring the abradable property at a high temperature. As the abradable metal layer of the base, the base layer surface is worked to be smooth and the thermally sprayed surface is used as the dimensional reference in some cases, in connection with the shroud production process. In this case, there is the method which applies blast treatment onto the abradable metal layer of the base with a smooth surface, and further thermally sprays an MCrAlY alloy (M is at least any one of Co and Ni) as a bond layer in order to enhance adhesion, besides the method which applies blast treatment and thermally spraying a ceramic abradable layer onto the abradable metal layer of the base with a smooth surface.

In the shroud provided with the abradable function of such a configuration, a gap (ΔL) between the rotor blade tip end and the shroud which is set at a room temperature decreases due to the temperature difference of a thin rotor blade under combustion gas at the time of actuation of the gas turbine and the shroud provided in the thick casing. At this time, the ceramic abradable layer is damaged by sliding and reduced in thickness and forms a minimum gap (ΔLmin.) Thereafter, at a normal operation, the ceramic abradable layer is controlled to the substantially same value as the minimum gap (ΔLmin.) with shroud temperature control. By keeping the minimum gap (ΔLmin.), leakage of the combustion gas from the gap is eliminated, and the efficiency is enhanced. The abradable metal layer of the base with an abradable property at a high temperature has the role of preventing a damage of the blade from a trouble such as a sudden vibration or the like during a normal operation. Like this, by combination of complexation of metal abradable and ceramic abradalbe and gap regulation, operation can be performed with a minimum gap. The configuration of the bond layer and the ceramic abradable layer are also included in the scope of the present invention since the compositions of the abladable metal layer and the bond layer are the same.

Meanwhile, the ZrO₂ ceramic layer with heat resistance taken into consideration has low thermal conductivity, and the ZrO₂ ceramic layer has lower thermal conductivity by further being made porous in order to ensure more abradable property. As a result, it is predicted that the frictional heat generated by abrasion is accumulated, the temperature of the abraded sliding portion becomes high, and sometimes locally reaches the melting temperature (about 1300° C.) of the Ni group heat resistant alloy, which causes reduction in hardness of the Ni group heat resistant alloy, or densification (increase in hardness) due to sintering of the porous ceramic layer, whereby seizure occurs at the abraded sliding portion, the abradable property is impaired, and the rotor blade tip end is significantly reduced in thickness and damaged. For generation/accumulation of such frictional heat, it is effective to dissipate heat as well as reduce the frictional heat generation area by reducing the contact area of the ceramic abradable layer and the rotor blade. More specifically, it is important to form slit grooves in the ceramic abradable layer and dissipate heat.

The present inventor et al. carried out abradable property evaluation at a high temperature. FIG. 4A shows a schematic view of the high temperature abrasion test. In the test, the abradable property up to the shroud temperature of the gas turbine was evaluated. A ceramic abradable layer was provided on the surface of a test piece 11 opposing a ring member 10 at a rotational side, and after heating them to a predetermined temperature by a heater 12, the test was started. The ring member is assumed to be a rotor blade, whereas the bar member is assumed to be a shroud, and an Ni group heat resistant alloy was used for both of them. The configuration of the ceramic abradable coating is as shown in FIGS. 1A to 1H, and an abradable metal layer (1 mm) was thermally sprayed, and a ceramic abradable layer was thermally sprayed thereon in sequence. After thermal spraying was finished, slit grooves were formed in the ceramic abradable layer by machining work. The slit grooves substantially penetrate through the ceramic abradable layer. In the present test, the rotational frequency of the ring material 10 (outside diameter φ 40 mm, thickness 1 mm) was 6000 rpm, the pressing load on the test piece 11 (φ 60 mm) was sequentially increased, and the test piece 11 was pressed to 80% of the thickness of the ceramic abradable layer. As a result, when the abradable property is scarce, the ring material and the ceramic abradable layer are seized. When the abradable property is favorable, seizure of the ring member and the ceramic abradable layer are not recognized at all, and the ceramic abradable layer is cut by the ring member. As shown in FIG. 4B, the abradable property was set as the ratio (d/D) of a thickness (d) of the ring member 10 and a width (D) of the groove formed in the ceramic abradable layer on the surface of the test piece 11. When the abradable property is favorable, d/D is close to 1. The test was carried out at the respective temperatures of a room temperature, 400, 600 and 800° C. In the present test, the porosity of the ceramic abradable layer was regulated, and the ceramic abradable layers of six standards of Rockwell superficial hardnesses (HR15Y) of the ceramic abradable layers of 92, 89, 85, 83, 77 and 75 were produced. In this case, for the ceramic abradable layer, slit working of a slit groove width of 1.0 mm was performed, in the shape of FIG. 1B, and the slit work interval was set at 2.8 mm (rectangle width 2.8 mm). The thickness of the ceramic abradable layer is 1 mm. The result is shown in Table 1.

TABLE 1
ELEMENT ABRASION TEST RESULT 1
(RECTANGLE WIDTH: 2.8 mm, CERAMIC ABRADABLE
LAYER THICKNESS: 1 mm)

| HARDNESS | TEMPERATURE | | | |
|---|---|---|---|---|
| (HR15Y) | (° C.) | d/D | REMARK | DETERMINATION |
| 92 | RT | 0.15 | | X |
| | 400 | — | SEIZURE | X |
| | 600 | — | SEIZURE | X |
| | 800 | — | SEIZURE | X |
| 89 | RT | 0.20 | | X |
| | 400 | — | SEIZURE | X |
| | 600 | — | SEIZURE | X |
| | 800 | — | SEIZURE | X |
| 85 | RT | 0.65 | | ◯ |
| | 400 | 0.58 | | ◯ |
| | 600 | 0.58 | | ◯ |
| | 800 | 0.58 | | ◯ |
| 83 | RT | 0.65 | | ◯ |
| | 400 | 0.60 | | ◯ |
| | 600 | 0.60 | | ◯ |
| | 800 | 0.58 | | ◯ |
| 77 | RT | 0.70 | | ◯ |
| | 400 | 0.65 | | ◯ |
| | 600 | 0.60 | | ◯ |
| | 800 | 0.60 | | ◯ |
| 75 | RT | 0.70 | | ◯ |
| | 400 | 0.65 | | ◯ |
| | 600 | 0.65 | | ◯ |
| | 800 | 0.65 | | ◯ |

—: UNMEASURABLE

In the case of the HR15Y of 92 and 89, a favorable abradable property cannot be obtained in any of the test temperatures. Meanwhile, in the case of the HR15Y of 85 and 75, a favorable abradable property was obtained in each of the test temperatures.

Table 2 shows the result of changing the slit groove width, and the rectangle width divided by the slit groove, in the case of the HR15Y of 83.

TABLE 2
ELEMENT ABRASION TEST RESULT 2
(HR15Y: 83, TEST TEMPERATURE: 800° C., CERAMIC
ABRADABLE LAYER THICKNESS: 1 mm)

| SLIT | REC- | | | |
|---|---|---|---|---|
| GROOVE | TANGLE | | | |
| WIDTH | WIDTH | | | |
| (mm) | (mm) | d/D | REMARK | DETERMINATION |
| 0.25 | 2 | 0.25 | | X |
| 0.5 | 0.5 | — | DAMAGED | X |
| | | | DURING TEST | |
| | 1 | 0.6 | | ◯ |
| | 2 | 0.6 | | ◯ |
| 2 | 0.5 | — | DAMAGED | X |
| | | | DURING TEST | |
| | 1 | 0.6 | | ◯ |
| | 2 | 0.6 | | ◯ |
| | 2.8 | 0.65 | | ◯ |
| | 4.6 | 0.6 | | ◯ |
| | 7 | 0.65 | | ◯ |
| | 10 | 0.25 | | X |
| 5 | 0.5 | — | DAMAGED | X |
| | | | DURING TEST | |
| | 1 | 0.6 | | ◯ |
| | 2 | 0.6 | | ◯ |
| | 2.8 | 0.65 | | ◯ |
| | 4.6 | 0.6 | | ◯ |
| | 7 | 0.65 | | ◯ |
| | 10 | 0.25 | | X |
| 7 | 1 | — | DAMAGED | X |
| | | | DURING TEST | |
| | 1.4 | — | DAMAGED | X |
| | | | DURING TEST | |

The test temperature is 800° C. The test was carried out for five standards of the slit groove widths by machining work of 0.25 to 7 mm, and seven standards of the rectangle widths in the range of 0.5 to 10 mm, with the thickness of the ceramic abradable layer of 1 mm. As a result, the slit groove widths of 0.5 to 5 mm are effective, and with that of 0.25 mm, the effect of the slit groove is absent. Further, in the case of 7 mm or more, in the test piece of a limited dimension (corresponding to a component), the surface pressure received by the rectangular ceramic abradable layer becomes large, and the ceramic abradable layer of the rectangle width was damaged. Meanwhile, with respect to the rectangle width, favorable results were obtained with 1 to 7 mm in the range of the slit width of 0.5 to 5 mm. With the rectangle width of 0.5 mm, the ceramic abradable layer was damaged after the test. With the rectangle width of 10 mm, d/D after the test was small, and a favorable abradable property was not obtained. Accordingly, the rectangle width of the ceramic abradable layer is desirably 1 to 7 mm.

Table 3 shows the result of examining a relationship between the dimension of the rectangle widths of 2 and 7 mm divided by the slit groove width of 2 mm and the thickness of the ceramic abradable layer in the case of HR15Y of 83.

TABLE 3
ELEMENT ABRASION TEST RESULT 3
(HR15Y: 83, TEST TEMPERATURE 800° C.)

| SLIT | RECTANGLE | THICK- | | |
|---|---|---|---|---|
| WIDTH | WIDTH | NESS | | |
| (mm) | (mm) | (nm) | REMARK | DETERMINATION |
| 2 | 2 | 1 | 0.55 | ◯ |
| | | 2 | 0.6 | ◯ |
| | | 3 | 0.6 | ◯ |
| | 7 | 1 | 0.6 | ◯ |
| | | 2 | 0.65 | ◯ |
| | | 3 | 0.65 | ◯ |

The test temperature is 800° C. Up to the thickness of the ceramic abradalbe layer of 3 mm, favorable abradable properties were obtained in both of the rectangle widths of 2 mm and 7 mm. The thickness of the ceramic abradable layer of 3 mm or more is the dimension beyond the range of the gap regulation.

As a result of the above examination, it is found that as for the abradable property at the temperature of the shroud exposed to the combustion gas of the gas turbine, the porosity of the ceramic abradable layer is regulated, and the range of the ceramic abradable layer in which the rectangle width divided by the slit groove of 0.5 to 5 mm is 1 to 7 mm, and the Rockwell superficial hardness (HR15Y) is 80±5 is the range in which the abradable property at the shroud temperature is favorable.

In order to evaluate durability to thermal stress of actuation and stoppage, the thermal cycle test repeating heating and cooling was carried out. The dimension of the test piece was 75×140×3 mm, and an abradable metal layer (1 mm), and a ceramic abradable layer thereon are sequentially thermally sprayed. As the ceramic abradable layer, the test piece provided with the ceramic abradable of the present invention with the determination in Table 2 being favorable, by machining work was used. As a result of repetition of the thermal cycle test (1000° C.×1 h [symbol] cooling), after the test of 1000 times, a damage such as peeling was not found in any of the test pieces. A similar thermal cycle test was carried out for the ceramic abradable layer of a known example shown in FIG. 2A as a comparison material. In this case, the sectional shape of the ceramic abradable layer is conical, the dimension of the bottom surface portion is 3 mm, and the thickness (height) is 2 mm, with a pitch of 6 mm. In the test piece, peeling and falling off of the ceramic abradable layer occurred by repetition of about 250 times.

As for the durability against a long-time exposure at a high temperature, the durability for 1000 times (1000 h) was able to be confirmed in the thermal cycle test (holding for 1 h at 1000° C.) repeating the above described heating and cooling.

### EXAMPLES

Hereinafter, favorable examples of the present invention and comparative examples thereof will be described.

### Example 1

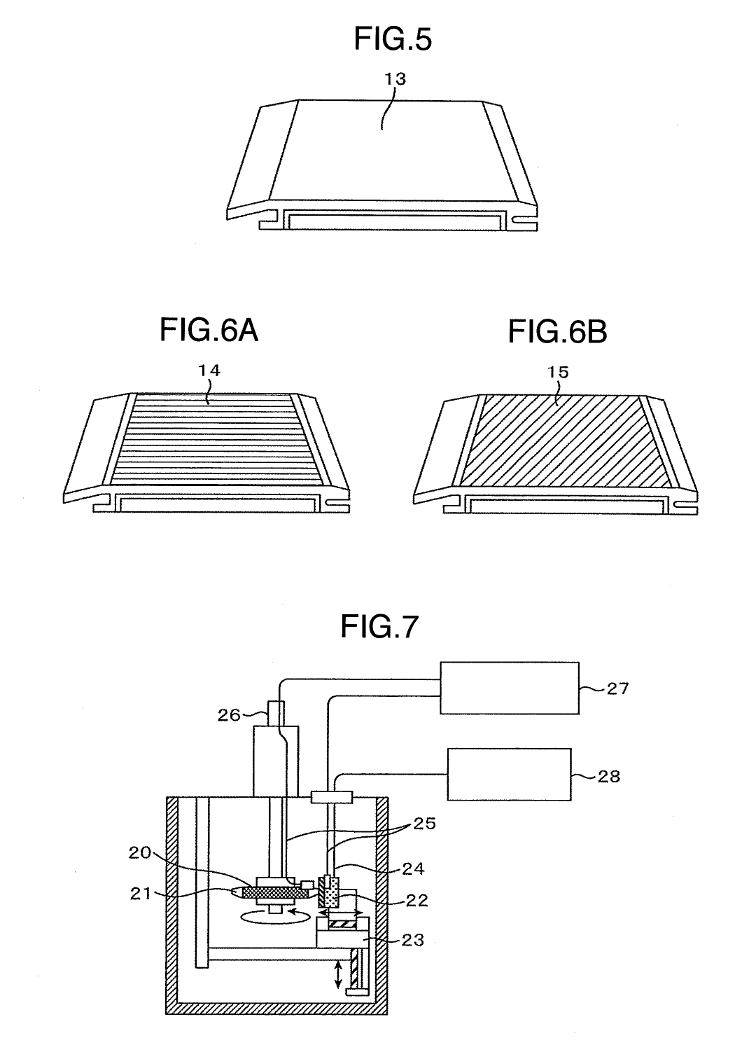

FIG. 1C shows a schematic sectional view of the abradable coating produced according to the method for forming the abradable coating of the present invention. FIG. 5 shows a shroud of an Ni group thermal resistant alloy used in the present example. The dimension is 75×145×18 mm. The abradable coating of the present invention was provided on a hot gas pass surface 13 of the shroud. On the base member, an MCrAlY alloy is thermally sprayed as the abradable metal layer (1 mm). As for the thermally spraying method, either plasma thermal spraying under a reduced pressure atmosphere, or high speed gas thermal spraying can be adopted. In the present example, a CoNiCrAlY alloy was thermally sprayed by plasma thermal spraying under a reduced pressure atmosphere. The thermally sprayed film thickness is 1.0 mm. The thermally spraying conditions are Ar—H₂ gas, plasma output of 40 kW, a thermal spraying distance of 250 mm and a powder feed amount of 60 g/min with use of a METCO 9 MB gun, and the atmosphere pressure during thermal spraying is about 200 Torr. Next, a ceramic abradable layer was thermally sprayed. The thermally spraying method is not especially limited, any of atmospheric plasma thermal spraying, reduced pressure atmosphere plasma thermal spraying, high-speed gas thermally spraying and the like can be adopted. In the present example, mixed powders of ZrO₂-8% Y₂O₃ and polyester powders were thermally sprayed by plasma thermal spraying in the air. The thermally sprayed film thickness is 1 mm. The thermal spraying conditions are use of a METCO 9 MB gun, N₂-H₂ gas, plasma output of 30 kW, a thermally spraying distance of 120 mm and the powder feed amount of 30 g/min. The mixed powder of ZrO₂-8% Y₂O₃ and polyester powders have 25% of polyester, and the hardness of thermally sprayed coating film (HR15Y) is 77. Next, a slit groove was formed on the ceramic abradable layer by machining work. The method for slit groove working is not especially limited. In the present example, slit groove working was carried out according to a water jet (WJ) method. As the conditions of WJ, slit groove working was carried out with a water medium, the nozzle diameter of φ0.2 mm, the flow rate of 0.5 L/min, and the pressure of 50 MPa. A rectangular ceramic abradable layer with the slit groove width of 3 mm and the rectangle width of 3 mm was formed. The sectional shape is trapezoidal as in FIG. 1C. FIG. 6A is a sketch drawing of the shroud after slit working. Slit grooves 14 were provided perpendicularly to the rotating direction of the rotor blade. In FIG. 6B, slit grooves 15 are provided in the direction of 45 degrees. The direction and the shape of the slit groove are not especially limited, but the slit groove shape as drawn in the straight line, or the slit groove shape in the curve shape as shown in FIGS. 6A and 6B are desirable. With the pattern similar to that of FIG. 6B, the ceramic abradable layer was formed by using masking according to the method of JP-A-2006-36632. In this case, the section of the ceramic abradable layer was conical as in FIG. 2A. The thermal cycle test repeating holding 1 h heating at 1000° C. [symbol] cooling was carried out with use of the shrouds having two kinds of abradable coatings according to the method for forming the abradable coating of the present invention and one kind of abradable coating according to a known method. As a result, in the shroud having the abradable coating according to the known method, part of the abradable coating peeled off and fell off by about 200 times. As a result of the examination of the damaged portion, the peeling origin occurred at the lower end portion of the ceramic abradable layer with a conical section. The shrouds having the two kinds of abradable coatings of the present invention were not damaged and were sound even after 1000 times of repetition. As a result of the examination after the test of 1000 times of repetition, a peeling origin or the like was not found in any portion of the ceramic abradable layers with rectangular sections.

### Example 2

With the thermal sprayed materials and the thermal spraying conditions similar to those of example 1, metal abradable layers and ceramic abradable layers were formed on the shroud of FIG. 5 shown in example 1, and slit grooves were formed by machining work. In the present example, slit groove working was carried out with use of a cutting grindstone. For the ceramic abradable layers, work of the slit grooves of 2 mm with the rectangle width of 2 mm was performed, and the rectangular ceramic abradable layers with square sections of FIG. 1B were formed, and slits grooves in the shapes similar to FIGS. 6A and 6B were formed. In contrast with such abradable coatings of the present invention, a ceramic abradable layer was formed with use of masking according to the method of JP-A-2006-36632, as in example 1. In this case, the section of the ceramic abradable layer was conical as in FIG. 2A. As a result that the thermal cycle test repeating holding 1 h heating at 1000° C. [symbol] cooling as in example 1 was carried out, and in the abradable coating according to the method of JP-A-2006-36632, part of the abradable coating peeled off and fell off by about 200 times. Meanwhile, in the abradable coatings of the present invention, a damage was not found even after 1000 times of repetition.

### Example 3

According to the similar method to example 1, the abradable coating according to the method for forming the abradable coating of the present invention was produced, and the abradable property test by high-speed rotation was carried out. FIG. 7 shows a test configuration diagram, and in the test, a test piece 22 mounted to a traverse device 23 is pressed against a tip end of a test blade 21 mounted to a test rotor 20 (φ200 mm) which is rotating at a high speed. The blade portion of the test blade has a blade length of 22 mm, a blade width of 20 mm and a blade thickness of 6 mm, and the test piece provided with the abradable coating of the present invention is a flat plate of 60×60 mm with a thickness of 40 mm. The test machine is configured by a thermocouple 24 for measuring the temperature of the test piece, strain gauge measuring lines 25 for measuring strain, a slip ring 26 for the measuring lines, a strain measuring section 27, and a temperature measuring section 28. The abradable coating of the present invention has the ceramic abradable layer constituted of the slit grooves of FIG. 6B. As comparison, a ceramic abradable layer was formed with use of masking according to the method of JP-A-2006-36632 similarly to example 1. In this case, the section of the ceramic abradable layer was conical as in FIG. 2A. The rotation test was carried out with use of the test pieces having the two kinds of abradable coatings. In the test with the rotor rotational frequencies of 10000, 20000, and 33000 rpm, a damage in the abradable coating was not found after the test, and a slide mark of the rotor blade was found in the ceramic abradable layer in the test piece having the abradable coating of the present invention. A damage by abrasion was hardly found at the tip end of the rotor blade. Meanwhile, in the abradable coating test piece having the ceramic abradable layer with a conical section, which was produced as comparison, part of the ceramic abradalbe layer was peeled and fell off after the test. At the tip end of the rotor blade, seizure by an abrasion damage was found.

As a result of the above, it is found that the abradable coating according to the method for forming the abradable coating of the present invention has a favorable abradable property in the abradable test by the rotating device.

### Example 4

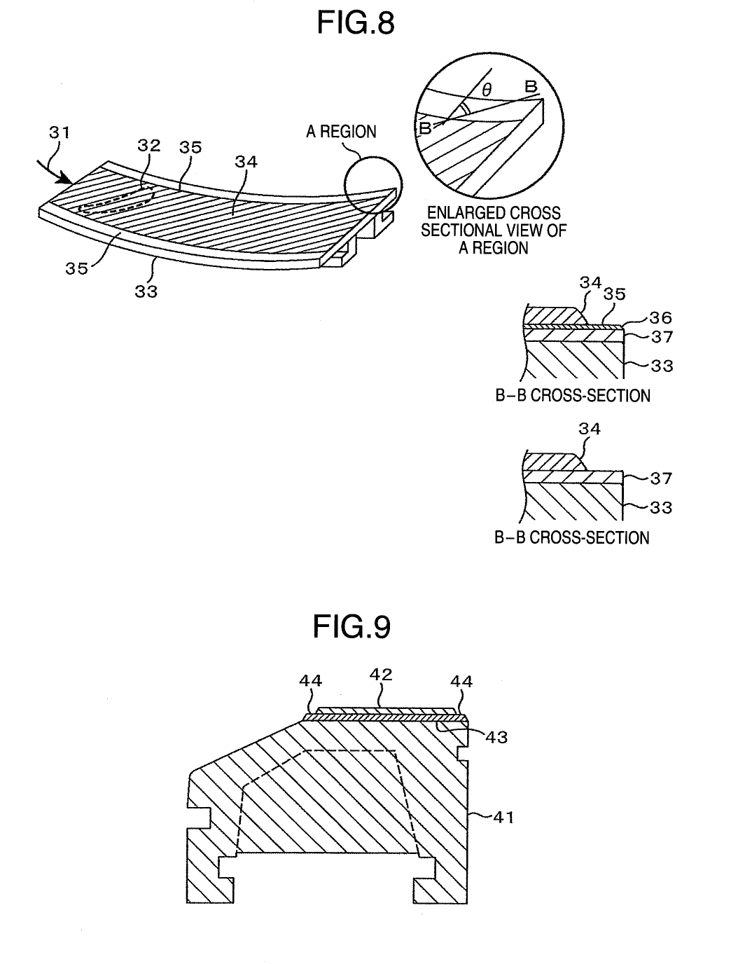

With the thermal sprayed materials and the thermal spraying conditions similar to those of example 1, base metal abradable of a thickness of 1 mm and a ceramic abradable layer of a thickness of 1 mm were formed on the shroud shown in FIG. 8, and a rectangular ceramic abradable layer with a slit groove width of 3 mm and a rectangle width of 3 mm shown by reference numeral 34 in FIG. 8 was formed in the similar conditions to example 1 by WJ work. The sectional shape of the rectangular ceramic abradable layer is also trapezoidal as in FIG. 1C similarly to example 1. In the present example, a bond layer shown by reference numeral 36 in FIG. 8 was provided between an abradable metal layer of the base (37 in FIG. 8) and a ceramic abradable layer (34 in FIG. 8). The bond layer is a CoNiCrAlY alloy layer with a thickness of 0.2 mm by HVOF thermal spraying. With respect to a rotating direction (31 in FIG. 8) of a rotor blade tip end (32 in FIG. 8) shown by the broken line, the rectangular ceramic abradable layer at an angle in the direction corresponding to the rotor blade rear edge portion is provided. In the present example, an angle shown by θ in FIG. 8 is 64.5 degrees. As the effect of the present example of providing the rectangular ceramic abradable layer at the angle in the direction corresponding to the rotor blade rear edge portion, the gap between the rectangular ceramic abradable layer and the tip end of the rotor blade which is rotating can be made small at the rear edge portion where the workload in the rotor blade becomes large, in the gap between the rotor blade tip end and the shroud, and a significant contribution can be made to enhancement in efficiency.

Reference numeral 35 in FIG. 8 of the present example corresponds to a portion without the rectangular ceramic abradable layer as shown in a B-B section. The bond layer (36 in FIG. 8), and the abradable metal layer of the base (37 in FIG. 8) are provided on the surface of a shroud main body (33 in FIG. 8). Like this, the feature of the present invention is to provide the portions (35 in FIG. 8) without the rectangular ceramic abradable layer at the upstream side and the downstream side portions of the shroud, which is effective for precisely measuring the gap between the shroud and the rotor blade tip end at the time of assembly. In the case with the presence of the rectangular ceramic abradable layer, it is difficult to obtain the accurate gap due to the recessed and projected pattern. Another feature of providing the portion (35 in FIG. 8) without the rectangular ceramic abradable layer at the upstream side and downstream side portions (or both of axial end portions) of the shroud is to shift the rectangular ceramic abradable layer and the shroud end portions as shown in the B-B cross-section in FIG. 8. When the rectangular ceramic abradable layer and the shroud end portions correspond to each other, the boundary of the rectangular ceramic abradable layer and the bond layer is exposed by 180 degrees, and easily becomes the origin of high-temperature oxidation. Meanwhile, in the configuration shown in the B-B cross-section in FIG. 8, exposure of the boundary of the rectangular ceramic abradable layer and the bond layer becomes 90 degrees, and the boundary hardly becomes the origin of high-temperature oxidation, and peeling of the rectangular ceramic abradable layer due to high-temperature oxidation can be suppressed. As the method for forming the B-B cross-section in FIG. 8, the method can be cited, which forms a portion that is not subjected to thermal spraying by providing a mask or the like in the portion 35 in FIG. 8 at the time of thermal spraying of the ceramic abradable layer, or which removes the portion 35 in FIG. 8 by WJ working after thermal spraying to the entire surface. Any of the methods can be adopted without a special limitation in exhibiting the feature of the present invention. The bond layer 36 may be eliminated to expose the abradable metal layer 37 at the portion 35.

### Example 5

The ceramic abradable shroud of the present invention was produced on the shroud with a sectional shape shown in FIG. 9 similarly to example 6. In the shroud of the present example, the ceramic abradable layer was provided after machining work of the shroud was finished, and therefore, the surface of the abradable metal layer of the base is not worked, and remains in the thermally sprayed state. The ceramic abradable layer was provided thereon. Accordingly, the present example has a two-layer structure of the abradable metal layer of the base and the rectangular ceramic abradable layer. The rectangular ceramic abradable layer has the structure of FIG. 1G. An abradable metal layer (44 in FIG. 9) of the base was produced by thermal spraying similarly to example 1, the composition thereof was an NiCoCrAlY alloy, and the thickness was 1 mm. A ceramic abradable layer of 1.5 mm was provided thereon with the thermal sprayed material of the similar composition to example 1 according to the similar method. In WJ working, by performing groove working under the similar WJ conditions to example 1, the structure in which the ceramic abradable layer of about 0.1 mm remains in the groove portion can be formed after groove work, since the thickness of the ceramic abradable layer is 1.5 mm. The angle of the rectangular ceramic abradable layer was calculated and made 69 degrees from the idea similar to example 4. Further, the portion (44 in FIG. 9) without the rectangular ceramic abradable layer which is the feature of the present invention was provided at the upstream side and downstream side portions similarly to example 4. The manufacturing method and the effect thereof are similar to example 4.

### Example 6

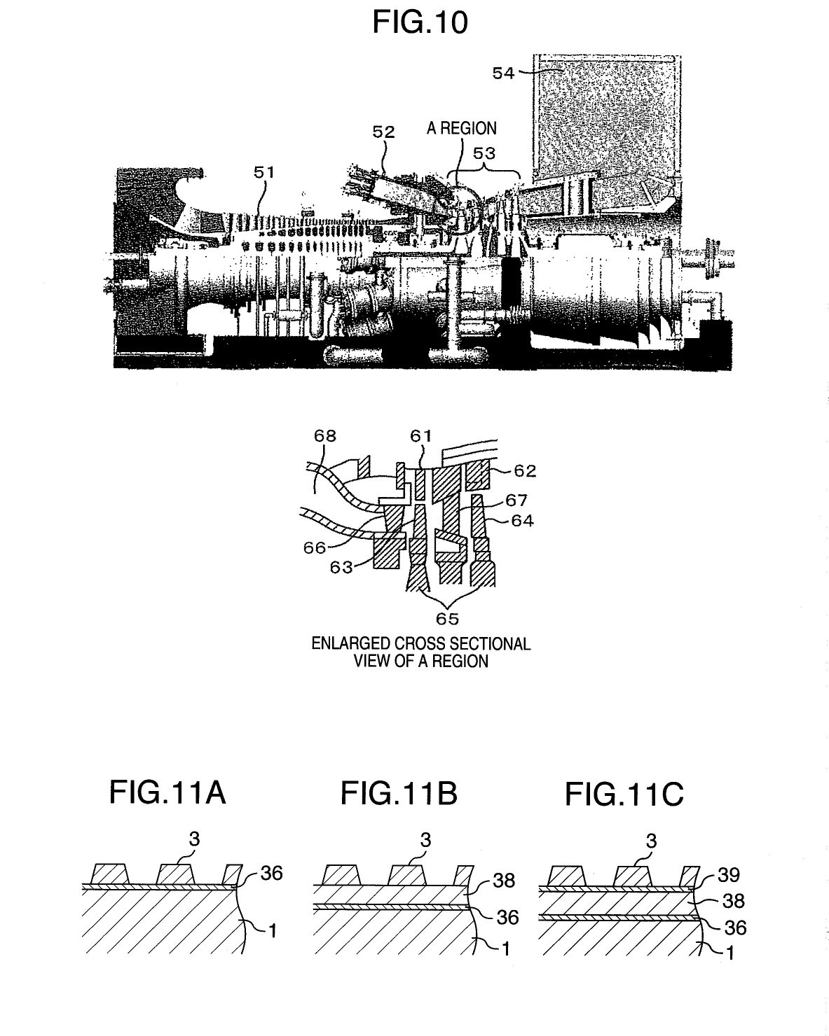

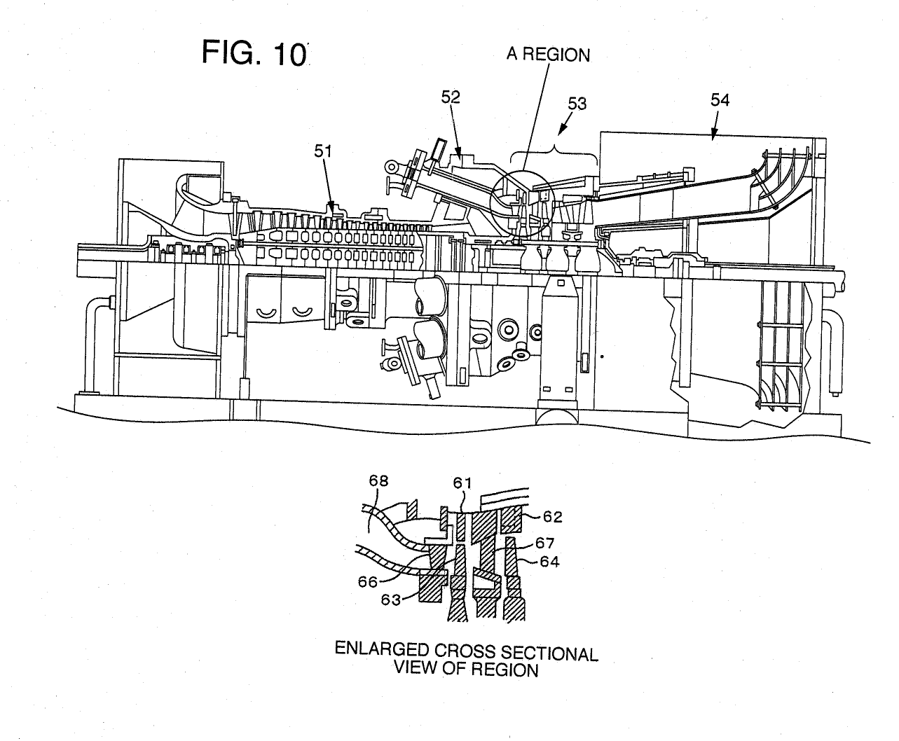

Shrouds of FIG. 8 and FIG. 9 having the abradable coatings according to the method for forming the abradable coating of the present invention, which were produced in examples 6 and 7 of the present invention were used for a gas turbine of 80 MW class shown in FIG. 10. In FIG. 10, reference numeral 51 designates a compressor, reference numeral 52 designates a combustor, reference numeral 53 designates a turbine section (stationary blade, a rotor blade and the like), and reference numeral 54 designates an exhaust section. The abradable shroud of the present invention of FIG. 8 was used for an initial stage shroud of 61 in an enlarged view of A region in FIG. 10, and the abradable shroud of the present invention of FIG. 9 was used for a second stage shroud of 62 of an enlarged view of the A region in FIG. 10. In the enlarged view of the A region in FIG. 10, reference numeral 63 designates an initial stage rotor blade, and reference numeral 64 designates a second stage rotor blade. These rotor blades are mounted to a disk designated by 65. High-temperature combustion gas flows from a combustor transition piece designated by 68 to an initial stage stationary blade designated by 66, the initial stage rotor blade designated by 63, a second stage stationary blade designated by 67 and a second stage rotor blade designated by 64, and is converted into rotational energy in the rotor blade.

As a result of the test operation of the gas turbine using the shrouds of FIGS. 8 and 9 having the abradable coating according to the method for forming the abradable coating of the present invention shown in FIG. 10, it is found that the gap between the initial stage rotor blade and the initial stage shroud, and the gap between the second stage rotor blade and the second stage shroud can be set to be minimum, and about 1% is obtained as an improvement of generating end efficiency.

### Example 7

Each of FIGS. 11A-11C shows a modification of a surface structure including the abradable coating of the invention applicable to a hot gas pass surface 13 of a shroud, for example, made of Ni-based heat resistive alloy and having a dimension of 75×145×18 mm as shown on FIG. 6. In FIG. 11A, the metal bond layer 36 is formed on the base member 1, and the ceramic abradable layer 3 is formed on the metal bond layer 36 and has a rectangular cross-sectional shape. In this structure, only the ceramic abradable layer 3 has an abradable characteristic. In FIG. 11B, the metal bond layer 36 is formed on the base member 1, a heat-shield ceramic layer 38 is formed the metal bond layer 36, and the ceramic abradable layer 3 is formed on the heat-shield ceramic layer 38 and has a rectangular cross-sectional shape. In this structure, both of the abradable characteristic and a heat-shield characteristic are obtained. In FIG. 11C, the metal bond layer 36 is formed on the base member 1, the heat-shield ceramic layer 38 is formed the metal bond layer 36, a ceramic under layer 39 is formed on the heat-shield ceramic layer 38, and the ceramic abradable layer 3 is formed on the ceramic under layer 39 and has a rectangular cross-sectional shape. In this structure, both of the abradable characteristic and the heat-shield characteristic are obtained, and the ceramic under layer 39 is effective for increasing a bonding strength between the heat-shield ceramic layer 38 and the ceramic abradable layer 3 even when the heat-shield ceramic layer 38 and the ceramic abradable layer 3 are different from each other in porosity, for example, the heat-shield ceramic layer 38 has high density, and the ceramic abradable layer 3 has high porosity. The porosity of the ceramic under layer 39 is higher than that of the ceramic abradable layer 3 and lower than the heat-shield ceramic layer 38. The thermal spraying used to form each of the metal bond layer 36 and the ceramic abradable layer 3 of this example is common with that of the example 1. The thermal spraying used to form each of the heat-shield ceramic layer 38 and the ceramic under layer 39 does not need to be specifically limited so that any one of a plasma spraying in the atmosphere, a plasma spraying in reduced pressure environment, a high-speed gas spraying and so forth is usable. In this example, the plasma spraying in the atmosphere with a sprayed material of ZrO₂-8% Y₂O₃ powder is used, a thickness of the heat-shield ceramic layer 38 is about 1 mm, and a thickness of the ceramic under layer 39 is about 0.3 mm. For the thermal spraying, a METCO 9 MB gun is used with Ar—H₂ gas, a plasma power is 50-70 kW, a spraying distance is 70-100 mm, and a supply rate of the sprayed material is 30 g/min. This example is common with the example 1 in the slit forming process, the slit width and the cross sectional shape of the slit. The thermal cycle test of repeating the thermal cycle between holding the shroud at 1000° C. for 1 hour and cooling was carried out on each of the examples of FIGS. 11A-11C, but no damage could be found on the abradable coating structure after 1000 times of the thermal cycles.

It should be further understood by those skilled in the art that although the foregoing description has been made on embodiments of the invention, the invention is not limited thereto and various changes and modifications may be made without departing from the spirit of the invention and the scope of the appended claims.

1. A shroud for a gas turbine having a rotor blade, comprising a base member, a metal abradable layer arranged on the base member, and a ceramic abradable layer arranged on the metal abradable layer to have a hot-gas passing surface to be arranged to face to the rotor blade, wherein the hot-gas passing surface has slits and a slide surface between the slits so that the rotor blade is slidable on the slide surface.

2. The shroud according to claim 1, wherein the slits and the slide surface form one of a rectangular shape and a trapezoidal shape in a cross section of the ceramic abradable layer taken along an imaginary plane parallel to a thickness direction of the ceramic abradable layer, and a width of each of the slits is 0.5-5 mm.

3. The shroud according to claim 1, further comprising a bond layer arranged between the ceramic abradable layer and the metal abradable layer and made of MCrAlY alloy, M being at least one of Ni and Co.

4. The shroud according to claim 3, wherein the ceramic abradable layer is prevented from being arranged on both ends of the bond layer in an axial direction of the gas turbine so that an exposed surface of the bond layer extends from each of the ends of the bond layer in respective axial direction of the gas turbine.

5. The shroud according to claim 1, wherein the ceramic abradable layer has a Rockwell superficial hardness (HR15Y) of 80±5.

6. The shroud according to claim 1, wherein the metal abradable layer is made of MCrAlY alloy, M being at least one of Ni and Co.

7. The shroud according to claim 1, wherein the slide surface has one of a flat shape and a concave shape to be prevented from having a convex shape in a cross section of the ceramic abradable layer taken along an imaginary plane parallel to a thickness direction of the ceramic abradable layer.

8. The shroud according to claim 1, wherein the ceramic abradable layer is prevented from being arranged on both ends of the metal abradable layer in an axial direction of the gas turbine so that a surface of the metal abradable layer extends from each of the ends of the metal abradable layer in respective axial direction of the gas turbine while being prevented from being covered by the ceramic abradable layer.

9. A method for forming a ceramic abradable layer for a hot-gas passing surface of a shroud facing to a rotor blade of a gas turbine, comprising the steps of:
forming a metal abradable layer on a base member of the shroud by thermal spraying,
forming the ceramic abradable layer on the metal abradable layer by the thermal spraying, and
forming slits on the ceramic abradable layer by machining.

10. The method according to claim 9, wherein the machining is one of a water jet cutting and a grinding stone cutting.

11. The method according to claim 9, wherein the step of forming the ceramic abradable layer is prevented from using a pattern mask corresponding to an arrangement of the slits.

12. A method for producing a shroud for a gas turbine having a rotor blade, comprising the steps of:
forming a metal abradable layer on a base member of the shroud by thermal spraying,
forming a ceramic abradable layer on the metal abradable layer by the thermal spraying, and
forming slits on the ceramic abradable layer by machining.

13. The method according to claim 12, wherein the machining is one of a water jet cutting and a grinding stone cutting.

14. The method according to claim 12, wherein the step of forming the ceramic abradable layer is prevented from using a pattern mask corresponding to an arrangement of the slits.

15. A shroud for a gas turbine having a rotor blade, comprising a base member, a heat-shield ceramic layer arranged on the base member, and a ceramic abradable layer arranged on the heat-shield ceramic layer to have a hot-gas passing surface to be arranged to face to the rotor blade, wherein the hot-gas passing surface has slits and a slide surface between the slits so that the rotor blade is slidable on the slide surface, and a porosity of the ceramic abradable layer is higher than that of the heat-shield ceramic layer.

16. The shroud according to claim 15, further comprising a ceramic under layer arranged between the heat-shield ceramic layer and the ceramic abradable layer to be stacked through the ceramic under layer, wherein a porosity of the ceramic under layer is lower than that of the ceramic abradable layer and higher than that of the heat-shield ceramic layer.
